(19) United States
(12) Patent Application Publication
(10) Pub. No.: US 2024/0346822 A1
(43) Pub. Date: Oct. 17, 2024

(54) DATA PROCESSING APPARATUS, DATA PROCESSING METHOD, AND STORAGE MEDIUM

(71) Applicant: SpoLive Interactive, Inc., Tokyo (JP)

(72) Inventors: Yuhei IWATA, Tokyo (JP); Yusuke HARA, Tokyo (JP)

(21) Appl. No.: 18/755,681

(22) Filed: Jun. 27, 2024

Related U.S. Application Data
(63) Continuation of application No. PCT/JP2022/048229, filed on Dec. 27, 2022.

(30) Foreign Application Priority Data
Dec. 28, 2021 (JP) 2021-214905

(51) Int. Cl. G06V 20/40

(52) U.S. Cl. CPC G06V 20/42; G06V 20/44

(57) ABSTRACT

A data processing apparatus records game data in sports. The data processing apparatus includes: a parameter input part that accepts an input of a parameter that can be designated for each of structuring elements, which are one or more elements for structuring the rules of a sport, a display control part that causes an entry screen to be displayed, the entry screen being configured to allow the selection of events that occur in a game of the sport, an event input part that accepts an input of event information corresponding to the event selected on the entry screen, a progress management part that determines the progress of the game on the basis of the parameter and the inputted event information, and an event registration part that causes a storage to store the progress of the game determined by the progress management part, in association with the event information.

### CROSS-REFERENCE TO RELATED APPLICATIONS

The present application is a continuation application of International Application number PCT/JP2022/48229, filed on Dec. 27, 2022, which claims priority under 35 U.S.C § 119(a) to Japanese Patent Application No. 2021-214905, filed on Dec. 28, 2021, contents of which are incorporated herein by reference in their entirety.

### BACKGROUND OF THE INVENTION

Methods for recording game data in sports competitions are known. Japanese Unexamined Patent Application Publication No. 2017-134811 describes a method in which game data can be recorded using data in which play content and a code corresponding to the play content are recorded through simple operations.

However, in the conventional apparatus for recording the game data in sports competitions, it has been necessary to implement different recording methods to record game data concerning sports with different rules.

### BRIEF SUMMARY OF THE INVENTION

The present disclosure focuses on this point, and its object is to provide an apparatus capable of recording game data in various sports with different rules.

A data processing apparatus according to a first aspect of the present disclosure includes: a parameter input part that accepts an input of a parameter that can be designated for each of structuring elements, which are one or more elements for structuring the rules of a sport; a display control part that causes an entry screen to be displayed, the entry screen being configured to allow a selection of an event that occurs in a game of the sport; an event input part that accepts an input of event information corresponding to the event selected on the entry screen; a progress management part that determines progress of the game on the basis of the parameter and the inputted event information; and an event registration part that causes a memory to store the progress of the game determined by the progress management part, in association with the event information.

A data processing method according to a second aspect of the present disclosure includes: accepting an input of a parameter that can be designated for each of structuring elements, which are one or more elements for structuring the rules of a sport; causing an entry screen to be displayed, the entry screen being configured to allow a selection of an event that occurs in a game of the sport; accepting an input of event information corresponding to the event selected on the entry screen; determining progress of the game on the basis of the parameter and the inputted event information; and causing a memory to store the progress of the game determined in the determining of the progress, in association with the event information, that are executed by a computer.

A storage medium according to a third aspect of the present disclosure causes a computer to execute: accepting an input of a parameter that can be designated for each of structuring elements, which are one or more elements for structuring the rules of a sport; causing an entry screen to be displayed, the entry screen being configured to allow a selection of an event that occurs in a game of the sport; accepting an input of event information corresponding to the event selected on the entry screen; determining progress of the game on the basis of the parameter and the inputted event information; and causing a memory to store the progress of the game determined in the determining of the progress, in association with the event information.

### BRIEF DESCRIPTION OF THE DRAWINGS

FIG. 1 is a diagram illustrating an outline of a data processing system S.

FIG. 2 illustrates structuring elements of the rules of a sport.

FIG. 3 shows an example of parameters for identifying a sport.

FIG. 4 is a diagram illustrating an example in which a progress management part 134 manages the progress of a game on the basis of the parameters.

FIG. 5 is a block diagram showing a configuration of a data processing apparatus 1.

FIG. 6 is a diagram illustrating a data structure of template data stored in a storage 12.

FIG. 7 is a diagram illustrating a data structure of tournament template data stored in the storage 12.

FIG. 8 is a diagram showing a data structure of a player table stored in the storage 12.

FIG. 9 is a diagram illustrating an example of a data structure of event data stored in the storage 12.

FIG. 10 is a diagram illustrating an example of an entry screen displayed by a display control part 132.

FIG. 11 is a diagram illustrating an example of a sport selection screen displayed by the display control part 132.

FIG. 12 is a diagram illustrating an example of an entry screen displayed by the display control part 132.

FIG. 13 is a diagram illustrating an example of an entry screen displayed by the display control part 132.

FIG. 14 is a diagram illustrating an example of a data structure of event definition data stored in the storage 12.

FIG. 15 is a diagram illustrating an example of a player selection screen displayed by the display control part 132.

FIG. 16 is a diagram illustrating an example of a player selection screen displayed by the display control part 132.

FIG. 17 is a flowchart illustrating processing of the data processing apparatus 1.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### [Outline of a Data Processing System S]

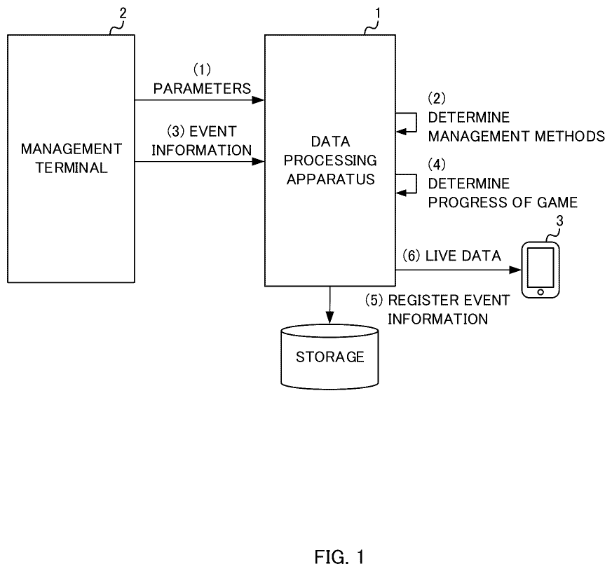

FIG. 1 is a diagram illustrating an outline of a data processing system S. The data processing system S is a system for acquiring information indicating the content of plays performed by players, the progress of a game, and the like in various sports competitions with different rules, and streaming information for play-by-play, commentary, or analysis of the game on the basis of the acquired information. The data processing system S includes a data processing apparatus 1, a management terminal 2, and an information terminal 3.

The data processing apparatus 1 acquires and records information concerning the content of plays performed by players and the progress of a game in various sports competitions with different rules. In the data processing apparatus 1, (i) a flow for determining the progress of a game (hereinafter simply referred to as a “flow”) and (ii) a configuration of a screen for entering information are determined on the basis of parameters specified for each of a plurality of structuring elements for determining the rules of sports. The data processing apparatus 1 can manage information concerning plays in various sports competitions with different rules by generating the flow on the basis of the specified parameters. It should be noted that the structuring elements are elements structured by extracting items common to the rules of two or more different sports.

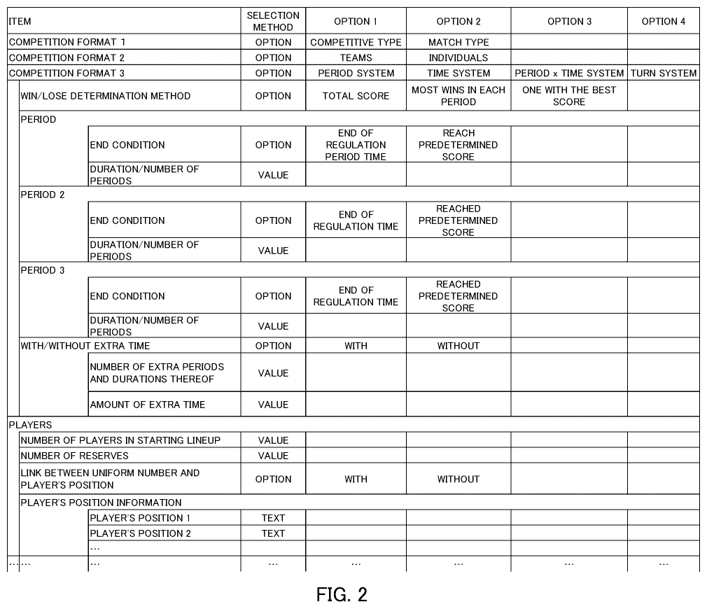

The flow in which the data processing apparatus 1 determines a management method of a competition on the basis of parameters specified for the structuring elements will be described with reference to FIGS. 2 to 4. FIG. 2 illustrates the structuring elements.

FIG. 2 shows an example of the structuring elements and values that can be specified for each structuring element. In FIG. 2, “competition format 1,” “competition format 2,” and “competition format 3” are structuring elements for determining the flow.

The “competition format 1” is a structuring element for determining the configuration of the flow and an entry screen. An administrator can select a parameter from among “competitive type” and “match type” for “competition format 1”. “Competitive type” corresponds to a competition format in which a plurality of players compete for records by one or more trials of the same competition. “Competitive type” is athletics, for example. “Match type” corresponds to a competition format in which individuals or teams compete for a win. “Match type” is ball games, martial arts, and the like, for example.

The “competition format 2” is parameters for determining whether a competition is to be performed by individuals or teams. The “competition format 3” is parameters regarding a method of determining a win or a loss in a competition. “Win/lose determination method” is parameters regarding how a competition proceeds. “Period system” refers to a competition where a game is divided into a plurality of periods, during which players compete for a win. “Period system” corresponds to tennis, table tennis, and the like, for example. “Time system” refers to a competition in which players compete for a win within a predetermined game duration. An example of a “time system” is 3×3 basketball. “Period x time system” refers to a competition where a game duration is divided into a plurality of periods, during which players compete for a win. “Period x time system” corresponds to soccer, rugby, basketball, and the like, for example. “Turn system” refers to a competition where the order of offense and defense is predetermined, and a predetermined number of attacks are repeatedly made in an alternating fashion, to compete for a win.

“Win/lose determination method” is parameters regarding a method of determining the outcome (winner) of a game. It is possible to select parameters such as “the one with the highest total score,” “the one with the most wins in each period,” or the like. “Period” is parameters regarding the number of periods, duration, and end condition of the period. When the periods are hierarchical in structure, parameters such as “period 2” and “period 3” are specified.

“With/without extra time” is parameters regarding (i) whether to go into extra time if the outcome remains undecided within regulation time and periods, (ii) the number of extra periods and durations thereof, and (iii) the amount of extra time. As will be described later, the structuring elements of the category “players” are parameters for determining a configuration of a participating player selection screen, an event entry screen, or the like. As an example, the structuring elements of the category “players” include “the number of players in the starting lineup,” “the number of reserves,” “link between uniform number and player's position,” and “player's position information”.

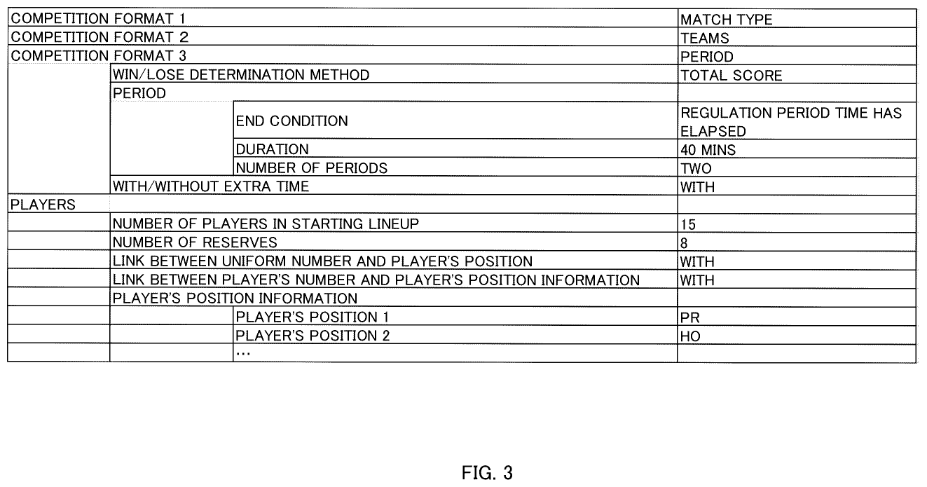

FIG. 3 shows an example of parameters determined for the structuring elements. FIG. 3 shows an example of parameters for the case of rugby. In the example of FIG. 3, “competition format 3=period×time system,” “win/lose determination method=total score,” “period (end condition)=end of regulation period time,” “period (duration)=40 minutes,” and “period (number of periods)=two” are specified.

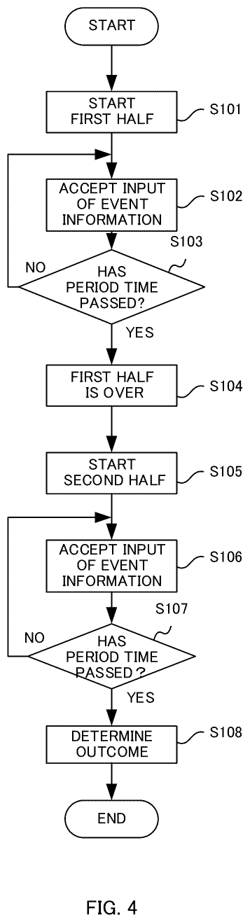

FIG. 4 shows the flow, generated on the basis of the parameters shown in FIG. 3, in which the data processing apparatus 1 determines the progress of a game. In the flow shown in FIG. 4, a flow of accepting an input of event information is repeated twice until a predetermined time passes on the basis of the specified parameters, and a flow of determining a win is generated when two periods (referred to as the first half and the second half) end.

Specifically, the data processing apparatus 1 determines that the first half (first period) is started (S101). Then, the data processing apparatus 1 accepts an input of event information (S102). The data processing apparatus 1 records the event information inputted while accepting the input of the event information as events that occurred in the first half. Here, events refer to individual moments or actions that occur during a game.

The data processing apparatus 1 determines whether event information indicating that a regulation period time has elapsed has been input (S103). If the event information indicating that the regulation period time has elapsed has not been input (NO in S103), the data processing apparatus 1 further accepts an input of event information (S102). If the event information indicating that the regulation period time has elapsed has been input (YES in S103), it is determined that the first half is over (S104).

Then, the data processing apparatus 1 determines that the second half is started (S105). The data processing apparatus 1 accepts an input of event information (S106). The data processing apparatus 1 records the event information inputted while accepting the input of the event information as events that occurred in the second half.

The data processing apparatus 1 determines whether event information indicating that the regulation period time has elapsed has been input (S107). If the event information indicating that the regulation period time has elapsed has not been input (NO in S107), the data processing apparatus 1 further accepts an input of the event information (S106). If the event information indicating that the regulation period time has elapsed has been input (YES in S107), it is determined that the second half is over, and determines the outcome of the game (S108).

Returning to FIG. 1, the management terminal 2 is a terminal for inputting data such as the parameters and the event information to the data processing apparatus 1. The information terminal 3 is a terminal that acquires live data and analysis data generated by the data processing apparatus 1. The management terminal 2 and the information terminal 3 are smartphones, tablets, or personal computers, for example.

The data processing apparatus 1 acquires the parameters from the management terminal 2 ((1) in FIG. 1). The data processing apparatus 1 determines management methods of sports competitions on the basis of the acquired parameters ((2) in FIG. 1). The management methods determined by the data processing apparatus 1 are the flow for determining the progress of the game and the configuration of the screen for inputting information, for example.

The management terminal 2 inputs the event information to the data processing apparatus 1 ((3) in FIG. 1). The data processing apparatus 1 determines the progress of the game on the basis of the parameters and the inputted event information ((4) in FIG. 1). The data processing apparatus 1 causes a storage 12 to store the progress of the game in association with the event information ((5) in FIG. 1). The data processing apparatus 1 transmits live data generated on the basis of the event information and the progress of the game to the information terminal 3 ((6) in FIG. 1).

### [Configuration of the Data Processing Apparatus 1]

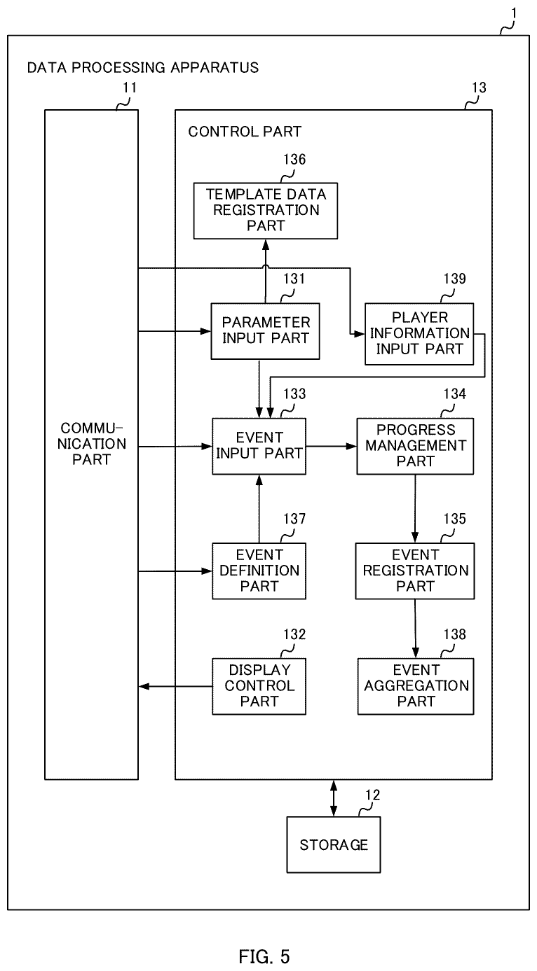

FIG. 5 is a block diagram showing a configuration of the data processing apparatus 1. The data processing apparatus 1 includes a communication part 11, the storage 12, and a control part 13. The control part 13 includes a parameter input part 131, a display control part 132, an event input part 133, a progress management part 134, an event registration part 135, a template data registration part 136, an event definition part 137, an event aggregation part 138, and a player information input part 139.

The communication part 11 is a communication interface for transmitting and receiving data to and from the management terminal 2 and the information terminal 3 via a network. The storage 12 includes a storage medium such as a ROM (Read Only Memory), a RAM (Random Access Memory), an SSD (Solid State Drive), and a hard disk. The storage 12 stores a program executed by the control part 13.

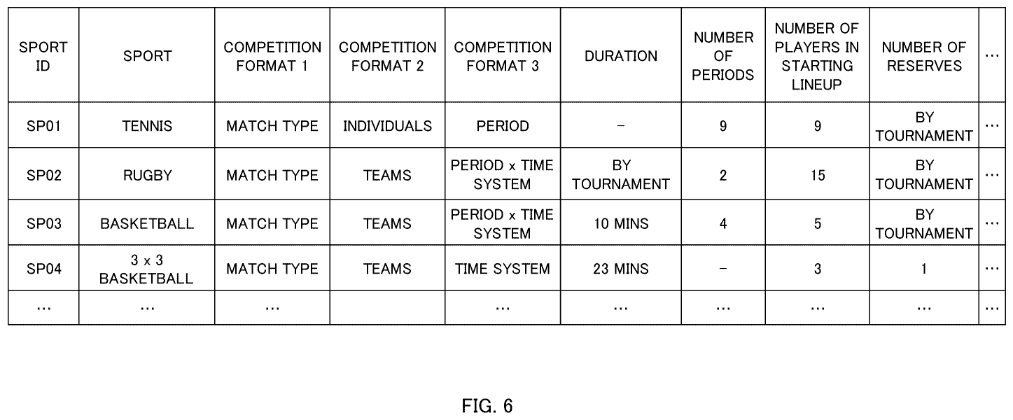

The storage 12 stores template data in which (i) one or more sports and (ii) one or more parameters corresponding to each of the one or more sports are associated with each other. FIG. 6 is a diagram illustrating a data structure of the template data stored in the storage 12. In the template data shown in FIG. 6, (i) a sport ID (identification) for identifying a sport competition, (ii) the name of the sport, and (iii) a parameter corresponding to each of a plurality of structuring elements are stored in association with each other. In the example of FIG. 6, as the structuring elements, information concerning at least Competition Format 1, Competition Format 2, Competition Format 3, duration, the number of periods, the number of players in the starting lineup, and the number of reserves are stored in association with each other.

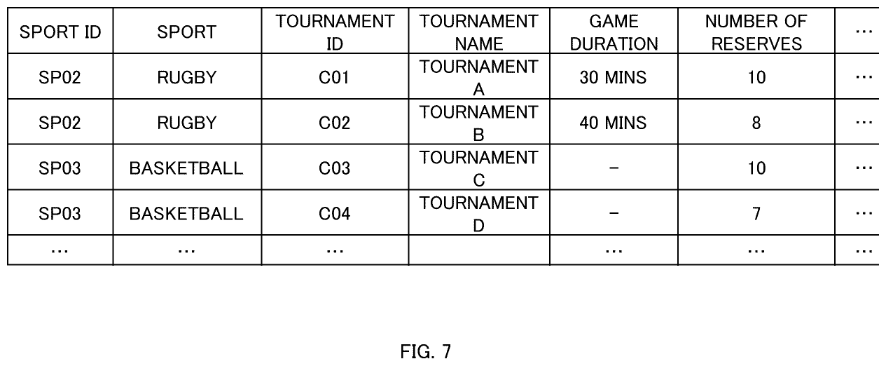

The storage 12 further stores tournament template data in which (i) one or more sports, (ii) one or more tournaments, each of which is a series of games where the same rules are applied to the one or more sports, and (iii) parameters corresponding to each of one or more structuring elements for which different parameters are applied to each tournament, from among the one or more structuring elements, are associated with each other. FIG. 7 is a diagram illustrating a data structure of the tournament template data stored in the storage 12. In the tournament template data shown in FIG. 7, the sport ID, a tournament ID for identifying a tournament, the name of the tournament, and parameters, having different values for each tournament, of the structuring elements to be designated in the tournament are stored in association with each other. In the example of FIG. 7, information concerning the game duration and the number of reserves is stored as the parameters having different values for each tournament.

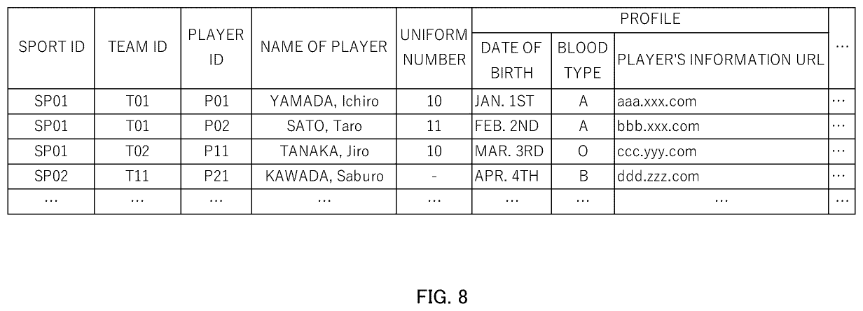

The storage 12 further stores a player table in which attributes of one or more players are recorded. FIG. 8 is a diagram showing an example of a data structure of the player table stored in the storage 12. In the player table shown in FIG. 8, the sport ID, a team ID for identifying a team to which a player belongs, a player ID for identifying the player, and the player's name, uniform number, and profile information are stored in association with each other.

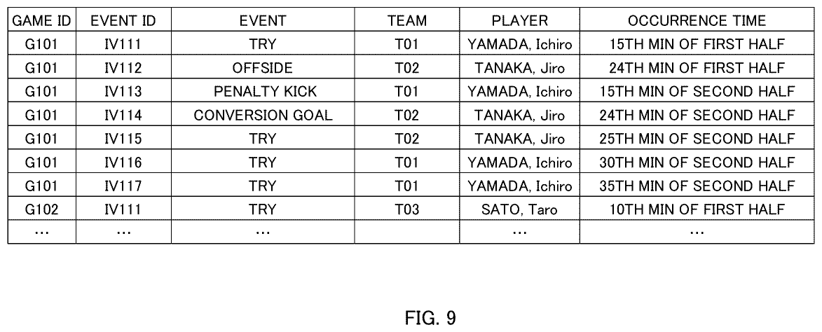

The storage 12 stores the event information accepted by the event input part 133. FIG. 9 is a diagram illustrating an example of a data structure of event data stored in the storage 12. In the event data, a game ID, an event ID, the content of an event, the team, the player, and the time of occurrence of the event are registered in association with each other.

The control part 13 includes a processor such as a central processing unit (CPU) or a graphics processing unit (GPU). The control part 13 functions as the parameter input part 131, the display control part 132, the event input part 133, the progress management part 134, the event registration part 135, the template data registration part 136, the event definition part 137, the event aggregation part 138, and the player information input part 139 by executing the program stored in the storage 12.

The parameter input part 131 accepts an input of parameters that can be designated for each of the structuring elements, which are one or more elements for structuring the rules of a sport. The parameter input part 131 accepts an input of parameters for each of the plurality of structuring elements from the management terminal 2. In the data processing apparatus 1, as one example, the display control part 132 causes the management terminal 2 to display a parameter entry screen configured to allow the parameters for each of the plurality of structuring elements to be entered. Then, the parameter input part 131 acquires the parameters entered on the parameter entry screen.

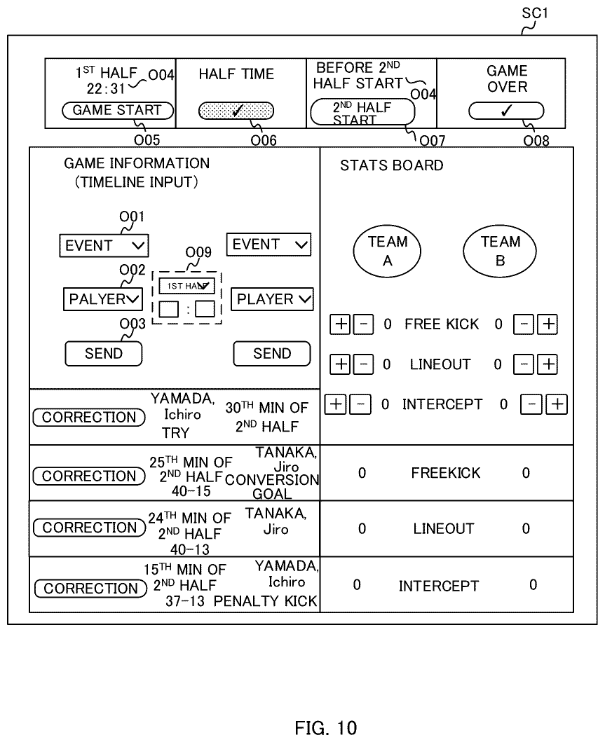

The display control part 132 causes an entry screen to be displayed, the entry screen being configured to allow the selection of events that occur in sports competitions. FIG. 10 is a diagram illustrating an example of an entry screen SC1 displayed on the management terminal 2 by the display control part 132. The entry screen SC1 is configured to select and enter events that occurred in the game. When the administrator presses a pull-down list O01, selectable events are displayed. As an example, in the pull-down list O01, events stored in event definition data, which will be described later, are displayed.

The event input part 133 accepts an input of event information corresponding to the event selected on the entry screen SC1. That is, when a send button O03 is pressed, the event input part 133 accepts the input of the event information selected in the pull-down list O01. As will be described later, the event input part 133 may further accept inputs of information concerning players related to an event and the time at which said event occurred.

The progress management part 134 determines the progress of the game on the basis of the parameters and the inputted event information. In FIG. 10, a screen is displayed in the case where “period x time system” is selected for “competition format 3,” and “40 minutes” and “two” are selected for “period (duration)” and “period (number of periods),” respectively. In FIG. 10, a game start button O05, a halftime start button O06, a second half start button O07, and a game end button O08 are disposed.

In the entry screen illustrated in FIG. 10, when the game start button O05 is pressed, the event input part 133 accepts event information indicating the start of the first half, and the progress management part 134 determines the progress of the game to be in the first half. Similarly, when the halftime start button O06 is pressed, the progress management part 134 determines the progress of the game to be at the end of the first half. When the second half start button O07 is pressed, the progress management part 134 determines that the second half has started. When the game end button O08 is pressed, the progress management part 134 determines that the second half is over.

When the game start button O05 is pressed, the progress management part 134 may display a timer O04 set to 40 minutes determined on the basis of 40 minutes of the parameter corresponding to “duration”. As an example, the timer O04 starts counting when the game start button O05 or the second half start button O07 is pressed, and the timer O04 stops when the halftime start button O06 or the game end button O08 is pressed. The progress management part 134 may determine an elapsed time since the start of the game on the basis of the timer.

The event registration part 135 causes the storage 12 to store the progress of the game determined by the progress management part 134, in association with the event information. As an example, when “try” is entered as the event information in the pull-down list O01 of the screen shown in FIG. 10, the event registration part 135 stores, in the event data stored in the storage 12, information in which the entered “try” is associated with “22 minutes in the first half” as the progress of the game.

There may be cases where the time indicated by the timer and the time the events occurred deviate from each other since it took the administrator time to register the events that occurred during the game. Therefore, the entry screen may be configured to allow the administrator to enter the event information by specifying the time. Specifically, the administrator enters the time at which the event occurred in an entry field O09 and performs an operation of pressing the send button. The event registration part 135 stores the inputted event information and the entered time in association with each other in the event data.

It is highly like that the parameters corresponding to a sport, once specified, are specified again. Therefore, if the data processing apparatus 1 is configured to store one or more parameters specified in association with the sport as templates, allowing the selection of the stored templates, it is highly convenient for the administrator.

Therefore, the template data registration part 136 causes the storage 12 to store template data in which sports and one or more parameters of the sport accepted by the parameter input part 131 are associated with each other. The template data registration part 136 associates (i) the sport entered on the parameter entry screen and accepted by the parameter input part 131 and (ii) the parameters specified for each of the plurality of structuring elements, and stores them in the template data stored in the storage 12.

When parameters set for each tournament are entered on the parameter entry screen, the template data registration part 136 associates (i) sports, (ii) tournaments, and (iii) parameters different for each tournament with each other, and stores them in the tournament template data stored in the storage 12.

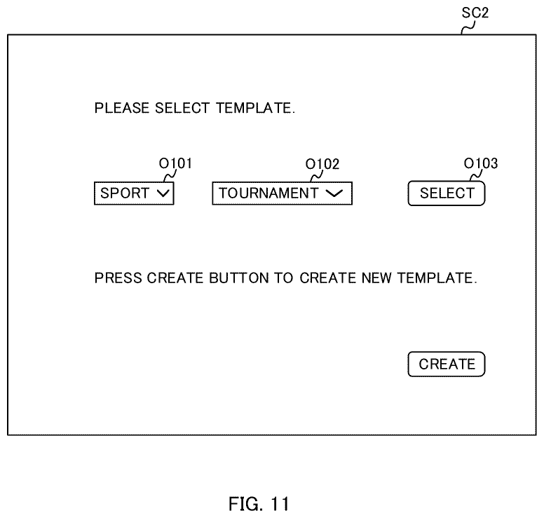

The display control part 132 further causes a sport selection screen to be displayed, the sport selection screen being configured to allow the selection of the one or more sports stored in the template data. FIG. 11 is a diagram illustrating an example of a sport selection screen SC2 displayed by the display control part 132. In the sport selection screen SC2 shown in FIG. 11, a pull-down list O101 for selecting a sport and a select button O103 are disposed. When the pull-down list O101 is clicked, a list of sports registered in the template data 102 is displayed.

The progress management part 134 determines the progress of a game on the basis of (i) one or more parameters associated with the sport selected on the sport selection screen SC2 in the template data and (ii) the event information accepted by the event input part 133. That is, the parameter input part 131 accepts an input of the parameters corresponding to the sport selected by the administrator on the sport selection screen SC2 by referencing the template data stored in the storage 12. Then, the progress management part 134 determines the progress of the game on the basis of the parameters accepted by the parameter input part 131 and the event information accepted by the event input part 133.

In some cases, different parameters are applied to the same sport. For example, regarding the game duration, 40 minutes is applied in the cases of university tournaments and corporate tournaments, and 30 minutes is applied in the cases of tournaments played by participants of high school age and younger. In this way, when the data processing apparatus 1 is configuration to store different parameters as templates for each tournament, allowing the selection of the stored template, it is highly convenient for the administrator.

Therefore, the display control part 132 further causes a tournament selection screen to be displayed, the tournament selection screen being configured to allow the selection of a tournament in sports stored in the tournament template data. The sport selection screen SC2 illustrated in FIG. 11 functions as the tournament selection screen. In the sport selection screen SC2 shown in FIG. 11, a pull-down list O102 for selecting a tournament is disposed. When the pull-down list O102 is pressed a tournament corresponding to the sport selected in the pull-down list O101 is displayed from among the tournaments stored in the tournament template data stored in the storage 12.

The progress management part 134 determines the progress of the game further on the basis of the one or more parameters that are associated with the tournament, which is selected on the tournament selection screen, in the tournament template data. That is, the parameter input part 131 accepts an input of the parameters corresponding to the sport and the tournament that are selected by the administrator on the sport selection screen SC2 by referencing the tournament template data stored in the storage 12. Then, the progress management part 134 determines the progress of the game on the basis of the parameters accepted by the parameter input part 131 and the event information accepted by the event input part 133.

In some sports, there are cases where a location at which a play was made has a significant meaning. In such cases, when the data processing apparatus 1 is configured to allow the location at which the play was made to be input in association with the event information through simple operations, it is highly convenient for the administrator.

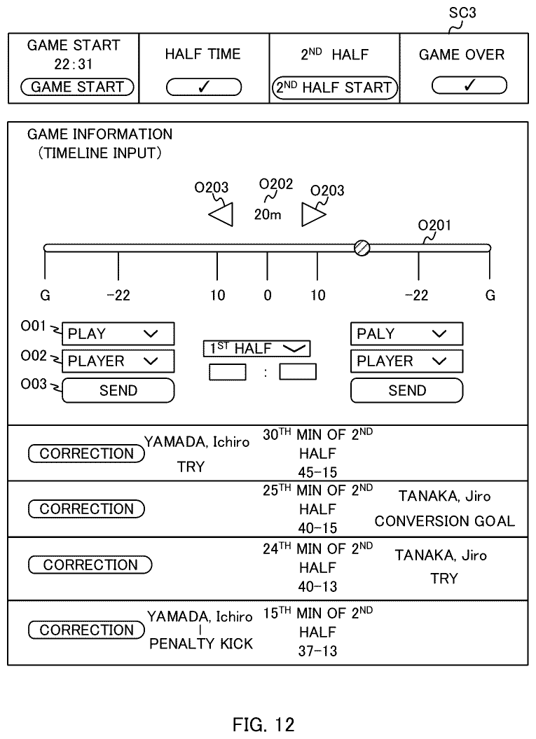

The display control part 132 causes an entry screen SC3 to be displayed, the entry screen SC3 being configured to further allow the selection of a location at which an event occurred in the game. FIG. 12 is a diagram illustrating an example of the entry screen SC3 displayed by the display control part 132. A slide bar O201 for selecting the location at which the event occurred is disposed. Here, end points of the slide bar O201 correspond to the end points (for example, locations of the goals) of a court where a competition is played, and a middle point of the slide bar O201 corresponds to the center of the court. The size of the court, locations of scales associated with the slide bar, and the content to be displayed on the scales may be determined on the basis of the parameters accepted by the parameter input part 131.

In the example of FIG. 12, the slide bar O201 is configured to manage only one-dimensional locations in an attacking direction, but a slide bar that manages location information in a direction perpendicular to the attacking direction may be further provided. The slide bar O201 is an example of a user interface for selecting the location at which an event occurred, and is not limited thereto. For example, the entry screen SC3 may be configured to display a screen indicating a field of a competition on the screen of FIG. 12 and allow the user to select a location at which the event occurred by an operation such as tapping on the displayed screen.

When the slide bar O201 is operated, the location on the court corresponding to the selected location on the slide bar is displayed in a display field O202. The location on the court can be adjusted by pressing the adjustment button O203. For example, pressing the adjustment button O203 disposed on the right increases the location on the court by 1 meter and pressing the adjustment button O203 disposed on the left decreases the location on the court by 1 meter.

The event registration part 135 further causes to store the location at which the event occurred in association with the event information. That is, when the administrator presses the send button O03, the event input part 133 accepts an input of information in which the event information selected in the pull-down list O01 and the location displayed in the display field O202 are further associated with each other. Then, the event registration part 135 stores the information in which (i) the event information whose input has been accepted by the event input part 133 and (ii) the location are associated with each other in the event data stored in the storage 12.

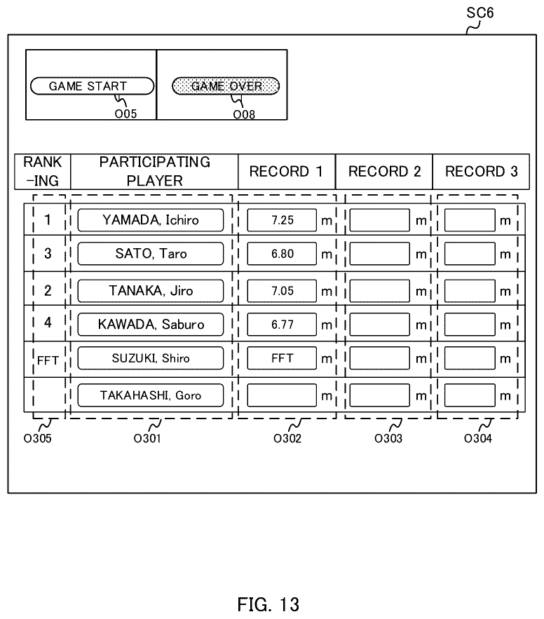

FIG. 13 is a diagram illustrating an example of an entry screen SC6 displayed by the display control part 132. FIG. 13 is an example of the entry screen SC6 corresponding to competitive type sports. That is, when “competitive type” is selected in the structuring element of “competition format 1,” the display control part 132 causes the entry screen SC6 shown in FIG. 13 to be displayed. In FIG. 13, a player name field O301, record input fields (O302, O303, and O304), and a ranking field O305 are displayed.

In the player name field O301, the names of the players participating in a competition are displayed. In the player name field O301, the players registered in the player table stored in the storage 12 are displayed in a selectable manner, for example. The player name field O301 may be configured to display a player selected on the participating player selection screen to be described later.

In the record input fields (O302, O303, and O304), it is possible to enter player's records as the event information. As an example, in the entry screen SC6 in FIG. 13, it is configured to allow the records of three trials to be entered in meters. The record input field may be configured to allow information concerning withdrawals, fouls, and the like to be entered. It should be noted that the number of record input fields disposed on the entry screen SC6 and the unit of records to be entered may be determined on the basis of the parameters of the structuring elements accepted by the parameter input part 131.

The progress management part 134 determines the rankings in the competition on the basis of the inputted event information. For example, the progress management part 134 determines the rankings on the basis of the order of the best records among each player's records. The order may be determined on the basis of the values of the structuring elements accepted by the parameter input part 131.

Then, the display control part 132 causes the ranking field O305 for each player to display the rankings determined by the progress management part 134. The progress management part 134 determines the progress of the game according to input states of the record input fields. As one example, the progress management part 134 may determine that the competition has started when the game start button O05 is pressed, and may determine that the first round is over when the record input fields O302 for the first round of all the players have been entered.

The event registration part 135 stores (i) the players displayed in the player name field O301, (ii) the event information indicating the records entered to the record input fields (O302, O303, and O304), and (iii) the progress of the game determined by the progress management part 134 in association with each other, in the event data stored in the storage 12.

Since the data processing apparatus 1 is configured to allow events that occur in sports competitions to be defined, play data of various sports can be recorded.

The event definition part 137 accepts inputs of (i) event information concerning the events that occur in sports and (ii) influence of the events on how the game proceeds. As an example, the display control part 132 causes the management terminal 2 to display an event definition screen configured to allow the content of an event and influence of said event on how the game proceeds to be entered. The event definition part 137 acquires the event information entered on the event definition screen. As an example, the event definition part 137 accepts an entry of information concerning the sport ID, the name of an event, a score to be added by an event, and a flag indicating whether or not a game ends due to an event.

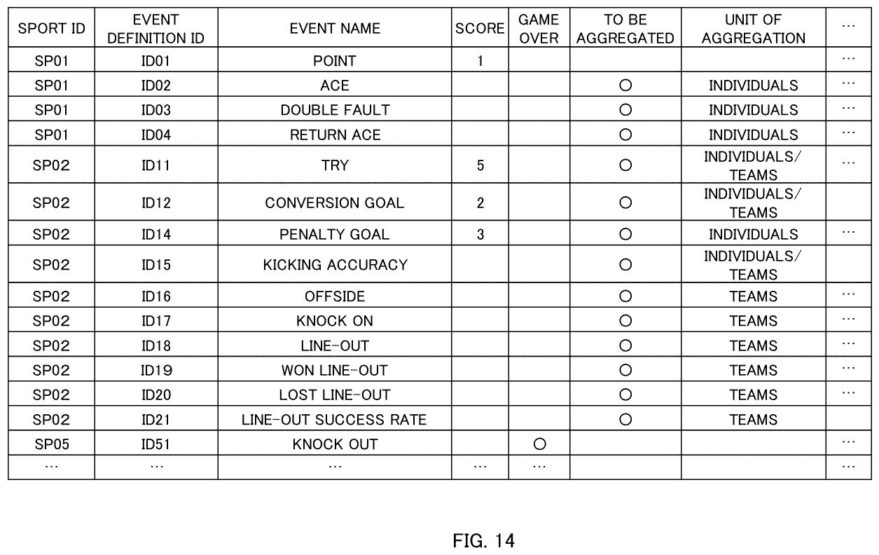

The event definition part 137 stores the entered event information in the event definition data. FIG. 14 is a diagram illustrating an example of a data structure of the event definition data stored in the storage 12. In the event definition data, the sport ID, an event definition ID, the name of an event, and a score are stored in association with each other. The score indicates a score to be added to the player or team who caused said event.

A game end flag may be stored in association with an event in the event definition data. The game end flag indicates that the game is over when said event is input. For example, it is set to “knockout” in boxing or the like.

The display control part 132 causes the entry screens (SC1, SC3) to be displayed, the entry screens being configured to allow the selection of the event information accepted by the event definition part 137. In the pull-down lists O01 on the entry screens (SC1, SC3), among the event information stored in the event definition data, the event information whose sport ID matches the sport being entered is displayed in a selectable manner.

The progress management part 134 determines the progress of the game on the basis of the parameters and the influence corresponding to the inputted event information. As one example, in a case where the parameter regarding the end condition of the period is set to reaching a predetermined score, the progress management part 134 calculates a total of scores associated with the event information, and determines that the period is over when the calculated total reaches the predetermined score.

If stats information can be provided on the basis of the inputted event information during or after the game, it is highly convenient for a user.

The storage 12 further stores event definition data in which one or more pieces of event information and an aggregation method of the event information are associated with each other. In the event definition data shown in FIG. 14, information concerning “to be aggregated” and “unit of aggregation” is stored in association with the event information. “To be aggregated” indicates whether or not an event is to be aggregated. A calculation formula may be defined by providing an item “calculation method” in addition to “to be aggregated”. For example, the “line-out success rate” is defined as “successful line-out throws/line-outs”.

The event aggregation part 138 aggregates the event information stored by the event registration part 135 on the basis of the aggregation method associated with the event information. As an example, the event aggregation part 138 totals the number of occurrences of an event in a game for the event information where “o” is entered in “to be aggregated”. The event aggregation part 138 may aggregate the event information on the basis of the defined calculation formula for event data in which the item “calculation method” is set in the event definition data.

The event definition part 137 further accepts an entry of the aggregation method of the event information which the definition part 137 has accepted as input. The event definition part 137 further accepts an entry of the event aggregation method on the event definition screen. In this case, the display control part 132 causes the event entry screen to be displayed, the event entry screen being configured to further allow the event aggregation method to be entered.

The event definition part 137 stores the accepted event information and aggregation method of the event information in association with each other in the event definition data, and the event aggregation part 138 aggregates the event information stored by the event registration part 135 on the basis of the aggregation method accepted by the event definition part 137 in association with the event information.

It may be desirable to register some event information, such as scores, in association with the information concerning players.

The display control part 132 causes the entry screens (SC1, SC3) to be displayed, the entry screens being configured to allow the selection of the players stored in the player table and the event information in association with each other. In the entry screens (SC1, SC3) shown in FIGS. 10 and 12, a pull-down list O02 for selecting a player is disposed. As an example, when the administrator presses the pull-down list O02, the players registered in the player table stored in the storage 12 are displayed in a selectable manner.

The event registration part 135 causes (i) the progress of the game determined by the progress management part 134, (ii) the selected event information, and (iii) the selected players, to be stored in association with each other. When the administrator presses the send button O03, information, in which the event information inputted to the pull-down list O01 and the player information indicating the player selected in the pull-down list O02 are further associated with each other, is stored in the event data stored in the storage 12.

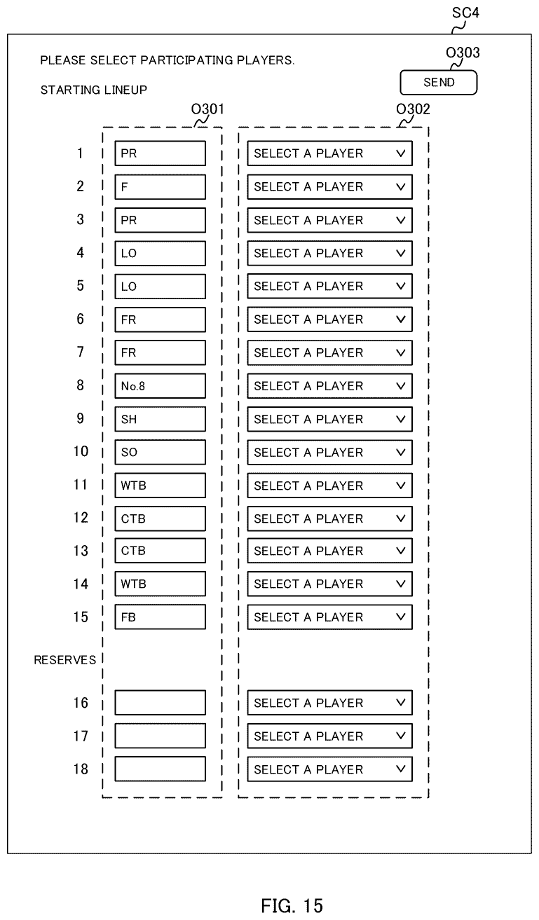

The display control part 132 further causes the participating player selection screen to be displayed, the participating player selection screen being configured to allow a selection of players (i.e., a squad) who will participate in the game from among the players stored in the player table. FIG. 15 is a diagram illustrating an example of the participating player selection screen displayed by the display control part 132. In a participating player selection screen SC4 shown in FIG. 15, a pull-down list O302 for selecting players is disposed.

The screen illustrated in FIG. 15 is configured according to selection results of the values of the structuring elements accepted by the parameter input part 131. As an example, the number of pull-down lists O302 to be arranged on the participating player selection screen SC4 is determined on the basis of the parameters specified for “number of players in the starting lineup” and “number of reserves”. Further, since “link between uniform number and player's position” is specified as “with”, an entry field of “uniform number” is not displayed on the participating player selection screen SC4. Further, since “with” is specified in “link between player's number and player's position information,” player's position information input as parameters is displayed in advance in a player's position input field O301.

The player information input part 139 accepts the selection of the squad of players who will participate in the game. When the administrator presses the pull-down list O302, the players stored in the player table are displayed in a selectable manner. The administrator selects the players who will participate in the game by operating the pull-down lists O302, and presses the send button O303. When the send button O303 is pressed, the player information input part 139 accepts an entry of player information. The player information input part 139 stores, in the storage 12, the squad of players who are selected on the participating player selection screen SC4 as the players who will participate in the game. As a result, the selected players can be selected in the pull-down list O02 on the entry screens (SC1, SC3).

The display control part 132 causes the entry screens (SC1, SC3) to be displayed, the entry screens being configured to allow the selection of the players who have been selected on the participating player selection screen in association with the event information. In this case, when the administrator presses the pull-down list O02 of the entry screens (SC1, SC3), the players who have been selected on the participating player selection screen from among the players stored in the player table are displayed.

Information such as the number of players who can participate differs for each sport. Further, in some sports, it may be necessary to input player and player's position information for each game. Therefore, when the participating player selection screen is configured according to the inputted parameters in the data processing apparatus 1, it is possible to make records of various sports with different rules.

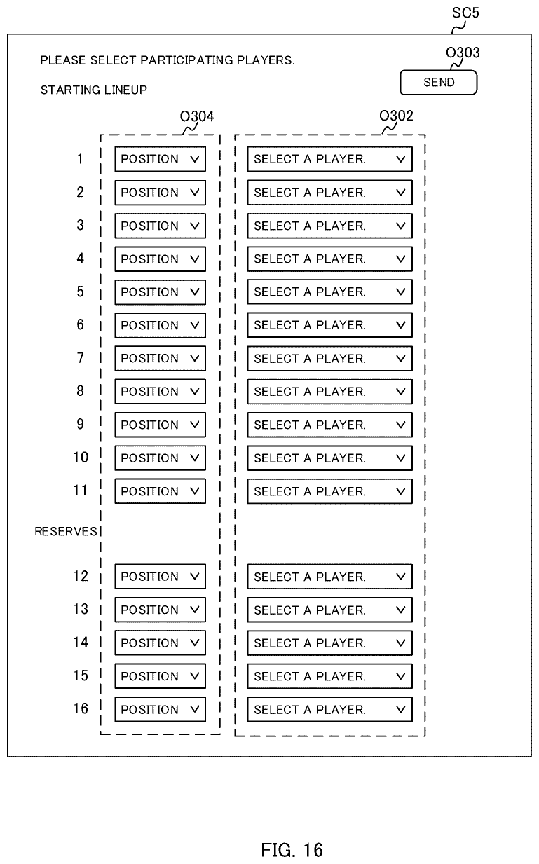

The display control part 132 determines attribute information that can be entered on the participating player selection screen on the basis of the parameters, and causes the participating player selection screen to be displayed, the participating player selection screen being configured to allow the determined attribute information to be entered in association with each of the participating players. FIG. 16 is a diagram showing an example of a participating player selection screen configured on the basis of parameters which are different from the parameters selected for generating the screen shown in FIG. 15. A participating player selection screen SC5 in FIG. 16 is configured to allow the selection of player's position information in association with players since “without” is selected in the structuring element of “link between uniform number and player's position”.

The player information input part 139 further accepts an input of the attribute information of the selected players. When the pull-down list O304 for selecting a player's position is pressed, the player's position information inputted as parameters of the player's position information is displayed in a selectable manner. When the administrator selects the player's positions and the players and presses the send button O303, the player information input part 139 accepts an input of the selected players and player's position information, and causes the storage 12 to store the selected players in association with player's position information. The stored player information can be selected on the event entry screens (SC1, SC3). As an example of the attribute information, the uniform number or the like may be input in addition to the player's position.

### [Processing of the Data Processing Apparatus 1]

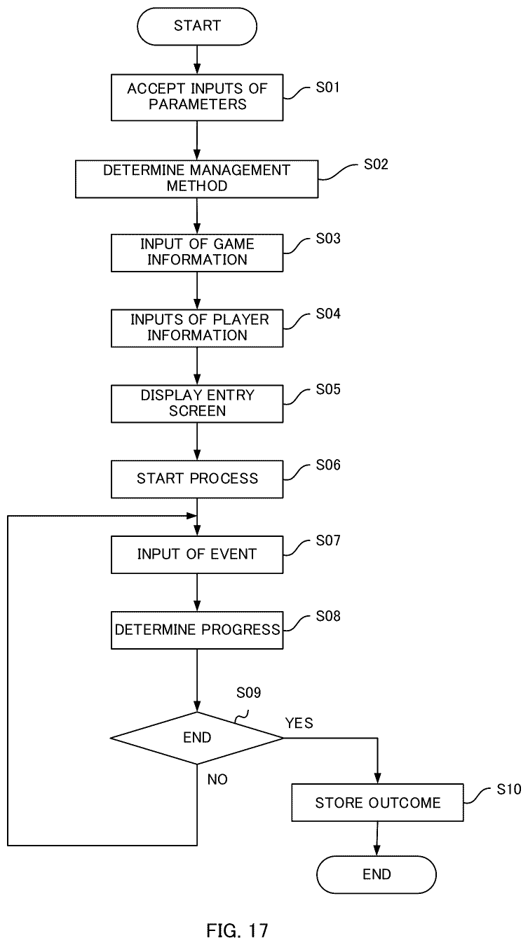

FIG. 17 is a flowchart illustrating processing of the data processing apparatus 1. The flowchart shown in FIG. 17 starts at a timing when the data processing apparatus 1 is activated and ready to accept inputs of parameters from the management terminal 2.

The parameter input part 131 accepts inputs of parameters (S01). The parameter input part 131 may accept the selection of a template and acquire parameters corresponding to the template. The progress management part 134 determines a management method on the basis of the inputted parameters. Specifically, the progress management part 134 determines a progress management flow and a screen configuration displayed by the display control part 132 (S02).

The event input part 133 accepts an input of game information (S03). The game information is information about teams playing a game and information about the date, time, location, and the like of the game, for example. The player information input part 139 accepts inputs of the player information on the participating player selection screen (S04).

The display control part 132 causes the entry screen to be displayed (S05). The event input part 133 performs a start process (S06). As an example, when the game start button is pressed on the entry screen, the start process is performed.

The event input part 133 accepts an input of event information (S07). The progress management part 134 determines the progress of the game on the basis of the inputted parameters and the inputted event information (S08).

Then, the progress management part 134 determines whether or not an end condition of the game is satisfied (S09). If the end condition of the game is not satisfied (NO in S09), the event input part 133 further accepts an input of the event information (S07). If the end condition of the game is satisfied (YES in S09), the data processing apparatus 1 causes the storage 12 to store the outcome of the game (S10). The data processing apparatus 1 may stream the outcome of the game to the information terminal 3. Then, the data processing apparatus 1 ends the process.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

What is claimed is:

1. A data processing apparatus comprising:
a parameter input part that accepts an input of a parameter that can be designated for each of structuring elements, which are one or more elements for structuring the rules of a sport;
a display control part that causes an entry screen to be displayed, the entry screen being configured to allow a selection of an event that occurs in a game of the sport;
an event input part that accepts an input of event information corresponding to the event selected on the entry screen;
a progress management part that determines progress of the game on the basis of the parameter and the inputted event information; and
an event registration part that causes a memory to store the progress of the game determined by the progress management part, in association with the event information.

2. The data processing apparatus according to claim 1, wherein
the memory stores template data in which (i) one or more of the sports and (ii) one or more of the parameters of each of the one or more sports are associated with each other, and
the data processing apparatus further comprises a template data registration part that causes the memory to store the template data in which (i) the sport and (ii) the one or more parameters corresponding to the sport accepted by the parameter input part are associated with each other.

3. The data processing apparatus according to claim 2, wherein
the display control part further causes a sport selection screen to be displayed, the sport selection screen being configured to allow a selection of the one or more sports stored in the template data, and
the progress management part determines the progress of the game on the basis of (i) the one or more parameters associated with the sport selected on the sport selection screen in the template data and (ii) the event information accepted by the event input part.

4. The data processing apparatus according to claim 3, wherein
the memory further stores tournament template data in which (i) the one or more sports, (ii) one or more tournaments, each of which is a series of games to which the same rules are applied for each of the one or more sports, and (iii) the parameters corresponding to each of one or more structuring elements for which different parameters are applied to each tournament, from among the one or more structuring elements, are associated with each other, and
the display control part further causes a tournament selection screen to be displayed, the tournament selection screen being configured to allow a selection of the tournament in the sports stored in the event template data, and
the progress management part determines the progress of the game further on the basis of the one or more parameters that are associated with the tournament selected on the tournament selection screen in the event template data.

5. The data processing apparatus according to claim 1, further comprising:
an event definition part that accepts inputs of (i) the event information concerning the event that occurs in the sport and (ii) influence of the event on how the game proceeds, wherein
the display control part causes the entry screen to be displayed, the entry screen being configured to allow a selection of the event information accepted by the event definition part, and
the progress management part determines the progress of the game on the basis of (i) the parameters and (ii) the influence corresponding to the inputted event information.

6. The data processing apparatus according to claim 5, wherein
the memory further stores event definition data in which one or more pieces of event information and an aggregation method of the event information are associated with each other, and
the data processing apparatus further comprises an event aggregation part that aggregates the event information stored by the event registration part on the basis of the aggregation method associated with the event information.

7. The data processing apparatus according to claim 6, wherein
the event definition part further accepts an input of an aggregation method of the event information whose input has been accepted by the event definition part, and stores the accepted event information and aggregation method of the event information in association with each other in the event definition data, and
the event aggregation part aggregates the event information stored by the event registration part on the basis of the aggregation method accepted by the event definition part in association with the event information.

8. The data processing apparatus according to claim 1, wherein
the display control part causes the entry screen to be displayed, the entry screen being configured to further allow a selection of a location at which the event occurred in the game, and
the event registration part further causes the memory to store the location at which the event occurred in association with the event information.

9. The data processing apparatus according to claim 1, wherein
the memory further stores a player table in which attributes of one or more players are recorded,
the display control part causes the entry screen to be displayed, the entry screen being configured to allow a selection of the one or more players stored in the player table and the event information in association with each other, and
the event registration part causes the memory to store (i) the progress of the game determined by the progress management part, (ii) the selected event information, and (iii) the selected one or more players, in association with each other.

10. The data processing apparatus according to claim 9, further comprising:
a player information input part that accepts a selection of the one or more players who will participate in the game, wherein
the display control part further causes a participating player selection screen to be displayed, the participating player selection screen being configured to allow a selection of the one or more players who will participate in the game from among the one or more players stored in the player table, and
causes the entry screen to be displayed, the entry screen being configured to allow a selection the one or more players who have been selected on the participating player selection screen in association with the event information.

11. The data processing apparatus according to claim 10, wherein
the display control part determines attribute information that can be entered on the participating player selection screen on the basis of the parameters, and displays the participating player selection screen configured to allow the determined attribute information to be entered in association with each of the participating players, and the player information input part further accepts an input of the attribute information of the selected players.

12. The data processing apparatus according to claim 1, wherein
the display control part determines, on the basis of the parameter, attribute information that can be entered on a participating player selection screen configured to allow a selection of players who will participate in a game,
and causes the participating player selection screen to be displayed, the participating player selection screen being configured to allow the determined attribute information to be entered in association with each of the participating players, and
the data processing apparatus further comprises a player information input part that accepts a selection of the players who will participate in the game and accepts an input of the attribute information of the selected players.

13. A data processing method executed by a computer, the method comprising:
accepting an input of a parameter that can be designated for each of structuring elements, which are one or more elements for structuring the rules of a sport;
causing an entry screen to be displayed, the entry screen being configured to allow a selection of an event that occurs in a game of the sport;
accepting an input of event information corresponding to the event selected on the entry screen;
determining progress of the game on the basis of the parameter and the inputted event information; and
causing a memory to store the progress of the game determined in the determining of the progress, in association with the event information.

14. A non-transitory storage medium storing a program that causes a computer to execute:
accepting an input of a parameter that can be designated for each of structuring elements, which are one or more elements for structuring the rules of a sport;
causing an entry screen to be displayed, the entry screen being configured to allow a selection of an event that occurs in a game of the sport;
accepting an input of event information corresponding to the event selected on the entry screen;
determining progress of the game on the basis of the parameter and the inputted event information; and
causing a memory to store the progress of the game determined in the determining of the progress, in association with the event information.
